(19) United States
(12) Patent Application Publication
(10) Pub. No.: US 2023/0294506 A1
(43) Pub. Date: Sep. 21, 2023

(54) INTEGRATED ELECTRICAL POWER GENERATION METHODS AND SYSTEMS

(71) Applicant: Cool Technologies, Inc., Tampa, FL (US)

(72) Inventors: Mark Hodowanec, Murrysville, PA (US); Timothy Hassett, Santa Rosa, CA (US); Steven Allen Padgett, North Huntingdon, PA (US)

(21) Appl. No.: 18/323,782

(22) Filed: May 25, 2023

Related U.S. Application Data
(63) Continuation of application No. 17/873,979, filed on Jul. 26, 2022, now abandoned.
Application No. 17/873,979 is a continuation of application No. 15/965,111, filed on Apr. 27, 2018, now abandoned.
(60) Provisional application No. 62/490,641, filed on Apr. 27, 2017.

(51) Int. Cl. B60K 6/48; B60K 6/36; F16H 3/00; B60W 20/40; B60W 20/20; B60L 50/61; B60L 58/12

(52) U.S. Cl. CPC B60K 6/48; B60K 6/36; F16H 3/006; B60W 20/40; B60W 20/20; B60L 50/61; B60L 58/12; B60W 2300/14; B60L 2200/28

(57) ABSTRACT

A method for providing electrical power at locations where shore power is unavailable, such as construction sites, remote utility sites, etc. Particularly, the method comprises simultaneously providing significant three phase power and significant single phase power. For example, in various instances the method comprises providing three phase power via generator of an integrated electrical power generation system, wherein the provided three phase power can be at least 50% of the rated power output of the generator, and simultaneously providing single phase power via a no-idle subsystem of the integrated power generation system, wherein the provided single phase power can be at least 3% of the rated power output of the generator.

### CROSS-REFERENCE TO RELATED APPLICATIONS

This application is a continuation of U.S. patent application Ser. No. 17/873,979 filed on Jul. 26, 2022, which is a continuation of U.S. patent application Ser. No. 15/965,111 filed on Apr. 27, 2018, which claims the benefit of U.S. Provisional Application No. 62/490,641, filed on Apr. 27, 2017. The disclosure of the above applications are incorporated herein by reference in their entirety.

### FIELD

The present teachings relate to systems and methods that integrate a generator with an energy storage system for the production single phase and/or three phase power in work environments isolated from main line electrical power.

### BACKGROUND

The statements in this section merely provide background information related to the present disclosure and may not constitute prior art.

Portable diesel and/or gasoline generators are often used to provide energy in areas that do not have access to electrical power. However, the power generated is often limited by the size of the generator. Typically, portable diesel and/or gasoline generators can be temporarily stationary generators place on site, tow behind generators, or be generator systems integrated as part of the vehicle wherein the vehicle engine is used as the prime mover to supply power to drive the generator. Traditional portable generators typically have a transformer, typically very small (e.g., 2 kVA), operable to covert a portion of the generated three phase power to single phase power. However, such generators are limited to producing either three phase power with very limited single phase power (e.g., 2 kVA single phase would be typical for a 70 kVA generator) or significant single phase power and no three phase power.

Such generators are typically driven by diesel and/or gasoline engines which are generally more efficient when running to drive the generator connected to a moderate load than they are when running at lower power levels to drive the generator connected to a smaller load. This is especially true of diesel engines. Additionally, modern diesel engines have an additional complication whereby at low power levels their exhaust systems, which are very expensive, wear out more quickly.

### SUMMARY

In various embodiments, the present disclosure provides a method for providing electrical power at locations where shore power is unavailable, such as construction sites, remote utility sites, etc. Particularly, in various instances the method comprises simultaneously providing significant three phase power and significant single phase power. For example, in various instances the method comprises providing three phase power via generator of an integrated electrical power generation system, wherein the provided three phase power can be in various instances at least 50% of the rated power output of the generator, and simultaneously providing single phase power via a no-idle subsystem of the integrated power generation system, wherein the provided single phase power can be in various instances at least 3% of the rated power output of the generator.

In various instances the provided three phase power can be between 50% and 100% of the rated power output of the generator, and the single phase power can be between 3% of the rated power output of the generator and 100% of the rated storage capacity of an energy storage system (e.g., a battery bank) of the no-idle subsystem.

In various instances the method further comprises simultaneously utilizing a portion of the power output by the generator to charge an energy storage system of the no-idle subsystem.

In various instances the method further comprising maintaining a state of charge of an energy storage system of no-idle subsystem between a minimum charge level and a maximum charge level that are respectively greater than 0% and less than 100% of the rated energy storage capacity of the energy storage system via an energy management system (e.g., battery management system) of the integrated electrical power generation system.

In various instances the state of charge of the energy storage system is maintained between 20% and 80% of the rated energy storage capacity of the energy storage system via an energy management system of the integrated electrical power generation system.

In various other embodiments, the present disclosure provides an integrated electrical power generation system, wherein the system comprises a generator structured and operable to output three phase power, a prime mover structured and operable to drive the generator, a power output control panel structured and operable to electrically connect at least one load to the integrated electrical power generation system and to control various settings and operational parameters of the integrated electrical power generation system, a voltage selector switch structured and operable to receive the generated three phase power from the generator and selectively distribute the received three phase power to one or more of: a transformer structured and operable to selectively raise and lower the electrical power received from the voltage selector switch and output the raised and lowered electrical power to the control panel, and a no-idle subsystem structured and operable to selectively receive electrical power from the voltage selector switch and to output voltage electrical power to the control panel.

In various instances the system is disposed on a pull-behind trailer.

In various instances the system is disposed partially on a pull-behind trailer and partially on a vehicle to which the pull-behind trailer can be connected.

In various instances system is disposed on a vehicle.

In various instances the prime mover is an engine of a vehicle whose primary function is to provide motive power to the vehicle.

In various instances the system is structured and operable to provide three phase power via generator of an integrated electrical power generation system, wherein the provided three phase power is at least 50% of the rated power output of the generator, and simultaneously provide single phase power via a no-idle subsystem of the integrated power generation system, wherein the provided single phase power can be in various instances at least 3% of the rated power output of the generator.

In various instances the system is structured and operable to the provide the three phase power between 50% and 100% of the rated power output of the generator, and provide the single phase power can be between 3% of the rated power output of the generator and 100% of the rated storage capacity of an energy storage system of the no-idle subsystem.

In various instances the system is structured and operable to simultaneously utilizing a portion of the power output by the generator to charge an energy storage system of the no-idle subsystem.

In various instances the system is structured and operable to maintain a state of charge of an energy storage system of the no-idle subsystem between a minimum charge level and a maximum charge level that are respectively greater than 0% and less than 100% of the rated energy storage capacity of the energy storage system via an energy management system of the integrated electrical power generation system via at least the energy management system of the integrated electrical power generation system.

In various instances the state of charge of the energy storage system is maintained between 20% and 80% of the rated energy storage capacity of the energy storage system via an energy management system of the integrated electrical power generation system.

In various other embodiments, the present disclosure provides a vehicle for providing electrical power at locations where shore power is unavailable, wherein the vehicle comprises an engine structured and operable to provide motive force to the vehicle, and an integrated electrical power generation system. In various instances the integrated electrical power generation system comprises a generator structured and operable to output three phase power, a prime mover comprising the vehicle engine further structured and operable to drive the generator, a control panel structured and operable to electrically connect at least one load to the integrated electrical power generation system and to control various settings and operational parameters of the integrated electrical power generation system, a voltage selector switch structured and operable to receive the generated three phase power from the generator and selectively distribute the received three phase power to one or more of: a transformer structured and operable to selectively raise and lower the electrical power received from the voltage selector switch and output the raised and lowered electrical power to the control panel, and a no-idle subsystem structured and operable to selectively receive electrical power from the voltage selector switch and to output voltage electrical power to the control panel.

In various instances the system is structured and operable to provide three phase power via the generator, wherein the provided three phase power is at least 50% of the rated power output of the generator; and simultaneously provide single phase power via the no-idle subsystem wherein the provided single phase power can be in various instances at least 3% of the rated power output of the generator.

In various instances the system is structured and operable to the provide the three phase power between 50% and 100% of the rated power output of the generator, and provide the single phase power can be between 3% of the rated power output of the generator and 100% of the rated storage capacity of an energy storage system of the no-idle subsystem.

In various instances the system is structured and operable to simultaneously utilizing a portion of the power output by the generator to charge an energy storage system of the no-idle subsystem.

In various instances the system is structured and operable to maintain a state of charge of an energy storage system of no-idle subsystem between a minimum charge level and a maximum charge level that are respectively greater than 0% and less than 100% of the rated energy storage capacity of the energy storage system via an energy management system of the integrated electrical power generation system via at least the energy management system of the integrated electrical power generation system.

The present disclosure generally provides an electrical power generation system (e.g., electrical current/voltage generation system) that integrates a portable diesel and/or gasoline generator with an energy storage system.

### DRAWINGS

The drawings described herein are for illustration purposes only and are not intended to limit the scope of the present teachings in any way.

FIG. 1 is a block diagram of an electrical power generation system that integrates a portable diesel and/or gasoline generator with a energy storage system, in accordance with various embodiments of the present disclosure.

FIG. 2 is a block diagram of a power output control panel of the integrated electrical power generation system shown in FIG. 1, in accordance with various other embodiments of the present disclosure.

FIG. 3 is a block diagram of a no-idle subsystem of the integrated electrical power generation system shown in FIG. 1, in accordance with yet other various embodiments of the present disclosure.

FIG. 4 is a schematic of the integrated electrical power generation system shown in FIG. 1 disposed on a pull-behind trailer, in accordance with still yet other various embodiments of the present disclosure.

FIG. 5 is a schematic of the integrated electrical power generation system shown in FIG. 1 have a portion disposed on a vehicle and a portion disposed on a pull-behind trailer, in accordance with still yet other various embodiments of the present disclosure.

FIG. 6 is a schematic of the integrated electrical power generation system shown in FIG. 1 disposed on a vehicle wherein the vehicle engine is utilized as a prime mover of the integrated electrical power generation system, in accordance with still yet other various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on,” “engaged to or with,” “connected to or with,” or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on,” “directly engaged to,” “directly connected to,” or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between,” “adjacent” versus “directly adjacent,” etc.).

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

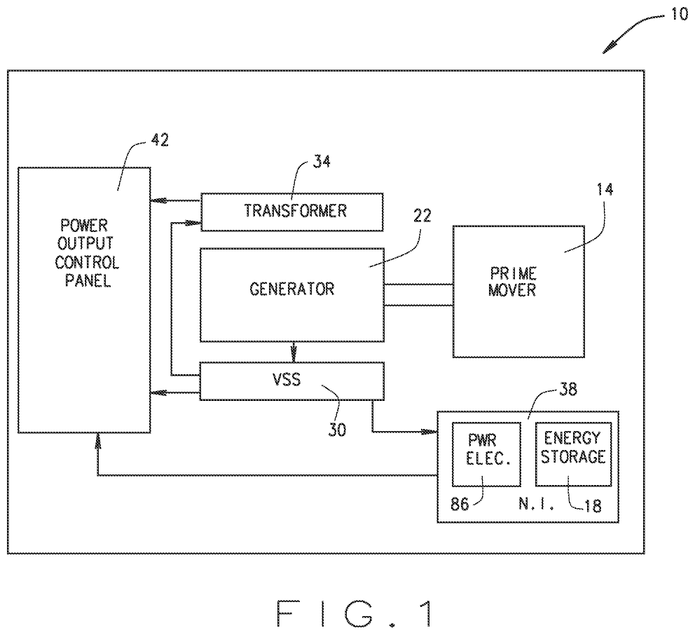

Referring now to FIG. 1, the present disclosure provides an integrated electrical power generation system 10 that is designed for power generation in on-site and/or remote locations where shore electrical power is not available. Particularly, the system 10 is structured and operable to: simultaneously output significant single phase power (e.g., 5 kVA or higher) and significant three phase power (e.g., 18 kVA or higher); efficiently utilize and operate a gasoline or diesel powered prime mover 14 of the system 10 (e.g., motor or engine) such that fuel consumption and wear/damage to the prime mover and associated exhaust system are minimized; and efficiently utilize and prolong the life of an energy storage system 18 of the system 10. The energy storage system 18 can be any suitable electrical energy storage system such as a battery bank comprising one or more battery (e.g., lead/zinc battery(ies), lithium ion battery(ies)), or any other known and unknown electrical energy storage system. The system 10 efficiently utilizes and operates the prime mover 14 by only operating the prime mover 14 at loads at which the prime mover 14 operates most efficiently, as opposed to operating the prime mover 14 at idle or low load speeds. The system 10 efficiently utilizes and prolongs the life of the energy storage system 18 by maintaining a state of charge (SOC) of the energy storage system 18 between a maximum and minimum state of charge (e.g., between 20% and 80% full charge).

Generally, the system 10 comprises the prime mover 14, a generator 22 (or alternator), a voltage selector switch (VSS) 30, a transformer 34, a no-idle subsystem 38 (that includes the energy storage system 18) and a power output control panel 42. Generally, in operation, the prime mover 14 is mechanically connected to the generator 22 such that operation of the prime mover 14 will drive the generator 22 to generate electrical power (e.g., to output voltage and current). Although the generator 22 is operable to output power, which is the product of voltage and current and power factor (e.g., V x Ix power factor), commonly in the art generator ratings and output are often referred to merely in terms of voltage and kVA. Therefore, throughout the present disclosure the generator 22 will be described as outputting voltage, but is should be understood that the generator 22 is operable to output electrical power (e.g., voltage and current). The generator 22 is electrically connected to the voltage selector switch 30, which enables an operator to select, set and control the voltage output, phase and distribution of the generator 22. In various embodiments, the voltage selector switch 30 can have three voltage output settings: 1) three phase high (e.g., 480 V); 2) three phase low (e.g. 208V and 240V); and 3) dedicated single phase (e.g., 240V & 120V). The transformer 34 is structured and operable to receive electrical power from the voltage selector switch and selectively raise and lower the electrical power (e.g., selectively raise and lower the voltage and/or current) received from the voltage selector switch 30.

As described further below, in various embodiments, the integrated electrical power generation system 10 can be entirely disposed on vehicle, or be entirely disposed on trailer, or be partially disposed on the vehicle and partially disposed on the trailer. Additionally, in various embodiments, the generator 22 can be driven by a prime mover 14 of the vehicle (e.g., a gasoline or diesel internal combustion engine of the vehicle), or a stand-alone prime mover 14 (e.g., a stand-alone gasoline or diesel internal combustion engine). Or, in various embodiments, the prime mover 14 can be integrated with the generator 22 in a single unit.

Throughout the present disclosure the generator 22 will be exemplarily described as a generator rated at a maximum output of 70 kVA (e.g., a 70 kVA generator), however it should be understood that the generator 22 could be any size and have any desired output rating, and remain with the scope of the present disclosure.

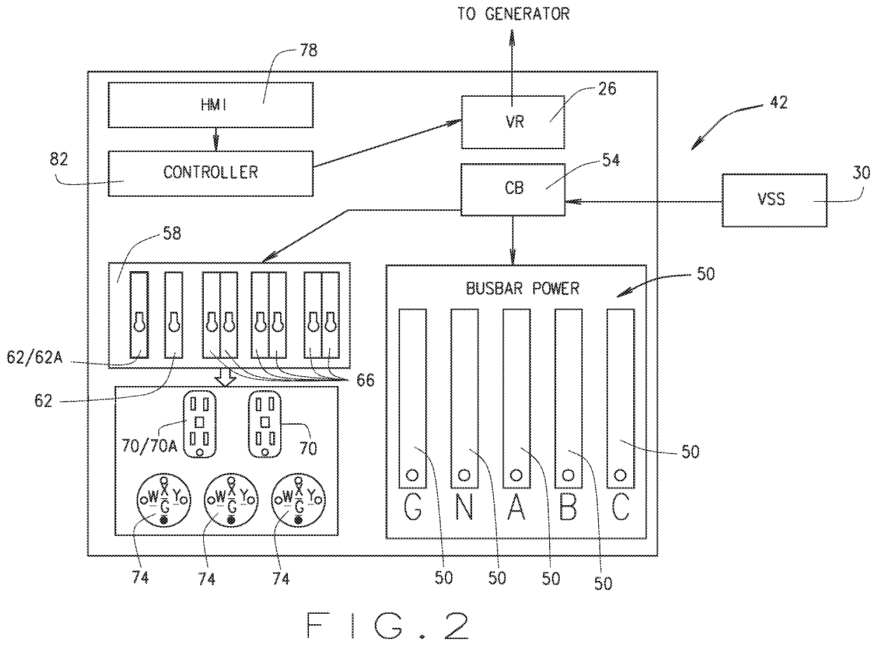

Referring now to FIGS. 1 and 2, generally the power output control panel 42 is structured and operable to electrically connect at least one load to the system 10 and to control various settings and operational parameters of the system 10. in various embodiments, the power output control panel 42 comprises a voltage regulator 46 that is structured and operable to control operation of the generator 22 to produce a desired or commanded voltage and current output. The power output control panel 42 additionally comprises busbars 50 that is electrically connected to and receives voltage output by the generator 22 via the voltage selector switch 30 and a main circuit breaker 54 that is electrically connected to the busbars 50. The busbars 50 and main circuit breaker 54 controls the flow of electrical energy to a breaker panel 58. The breaker panel 58 includes at least one single pole 120 V single phase breaker 62 and at least one double pole 240V single phase breaker 66. FIG. 2 exemplarily illustrates the breaker panel 58 including a plurality of single pole 120 V single phase breakers 62 and a plurality of double pole 240V single phase breakers 66. Each of the single phase breaker(s) 62 is/are electrically connected to and control(s) the flow of 120 V single phase electrical energy to a respective 120V single phase receptacle 70, and each of the double pole 240V single phase breakers 66 is/are electrically connected to and control(s) the flow of 240 V single phase electrical energy to a respective 240 V single phase receptacle 74.

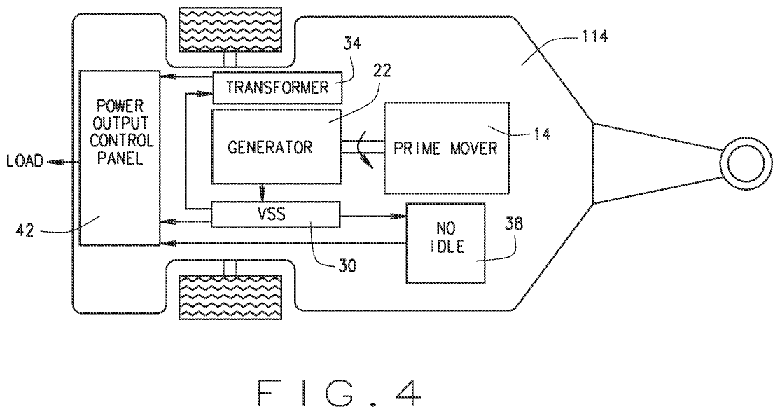

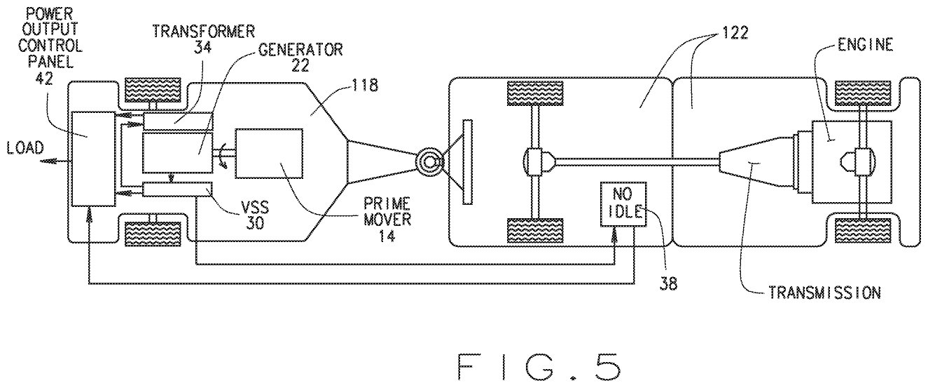

The power output control panel 42 further comprise a human machine interface (HMI) 78 and a controller 82. The HMI 78 enables an operator to provide an operator interface that allows an operator to communicate with the system 10. Particularly, the HMI 78 provides communication interface between an operator and the controller 82, whereby the operator can input desired operational parameters for operation of the system 10. The HMI can comprise any suitable user interface such as a keyboard, and/or a mouse, and/or a touch screen, etc. In various embodiments, wherein the prime mover 14 is a dedicated prime mover whose primary function is to drive the generator 22, as described further below with regard to FIGS. 4 and 5, the controller 82 receives inputs from and coordinates the operation of (e.g., receives inputs from and/or generates outputs to) at least the HMI 78, the voltage regulator 26 that controls operation of the generator 22, a prime mover controller (e.g., an engine control module), and a plurality of other devices/sensors, such as relays (e.g., an overload relay), generator temperature sensors, current transformers and/or breakers within the control panel 42, and other voltage sensor(s), current sensor(s), temperature sensor(s), etc., (not shown) of the system 10.

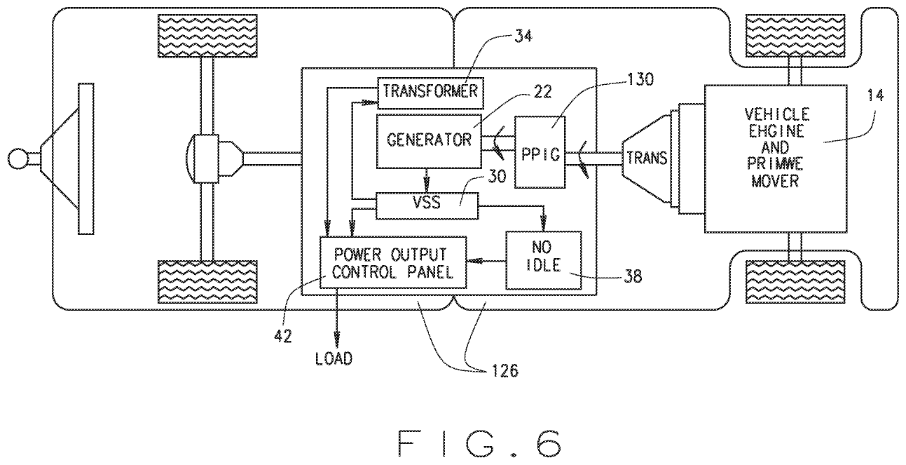

As described below with regard to FIG. 6, in various embodiments, the prime mover 14 can be the engine of a vehicle (such as a utility vehicle or truck) on which at least a portion of the system 10 is disposed, whose primary function is to provide motive power to the respective vehicle. In such embodiments, the controller 82 receives inputs from and coordinates the operation of (e.g., receives inputs from and/or generates outputs to) at least the HMI 78, a vehicle engine (prime mover 14) controller (in various instances called an power control module (PCM) or engine control module (ECM), not shown) that is operable to control operation of the vehicle engine (prime mover 14), the voltage regulator 26 that controls operation of the generator, and a plurality of other devices/sensors such as relays (e.g., an overload relay), vehicle engine (prime mover 14) and/or generator 22 temperature sensors, power take off (PTO) shifting mechanisms, current transformers and/or breakers within the control panel 42, and other voltage sensor(s), current sensor(s), temperature sensor(s), etc., (not shown) of the system 10.

As illustrated in FIG. 2, the voltage selector switch 30 is wired to the input side of the main circuit breaker 54 which functions in all three voltage and phase positions of the voltage selector switch 30. The voltage selector switch 30 can also be wire to the busbars 50 and/or the breaker panel 58. The output side of the main circuit breaker 54 is wired to the busbars 50 (functional in single phase and three phase voltage selector switch settings) and at least one of the single phase breaker(s) 62 and 66. Each single phase breakers 62 and 66 is individually wired to the corresponding single phase receptacle 70 and 74.

In various instances, the voltage selector switch 30 can be configured in such a way that there is always 120V power supplied to a dedicated one of the single phase receptacle(s) 70 (identified in FIG. 2 as receptacle 70A), via a corresponding one of the single phase breaker(s) 62 (identified in FIG. 2 as receptacle 62A) and the transformer 34, and the remaining single phase receptacle(s) 70 (if any) are only powered when the generator 22 is operated in dedicated single phase mode. In such instances, all of the 120V single phase breakers 62 are individually wired to a respective 120V single phase receptacle 70, and all of the 240V single phase breakers 66 are individually wired to a respective 240V single phase receptacle 74 in order to provide branch protection. Additionally, in dedicated single phase mode of the system 10, single phase power can be obtained through the A & B busbars, protected by the main circuit breaker 54, but without branch protection. In all of the three phase positions of the voltage selector switch 30, the dedicated single phase receptacle 70A receives 12V single phase power. In various instances, wherein the generator 22 is exemplarily a 70 kVA generator, when the generator 22 is in any of the three phase modes, the transformer 34 is limited to 2 kVA output power and the dedicated single phase receptacle 70A can be a 20A 120V receptacle. However, in various instances, wherein the generator 22 is in dedicated single phase mode, it is envisioned that the transformer 34 can output as much as 40 kVA to power a plurality of single phase receptacles 70 and/or 74.

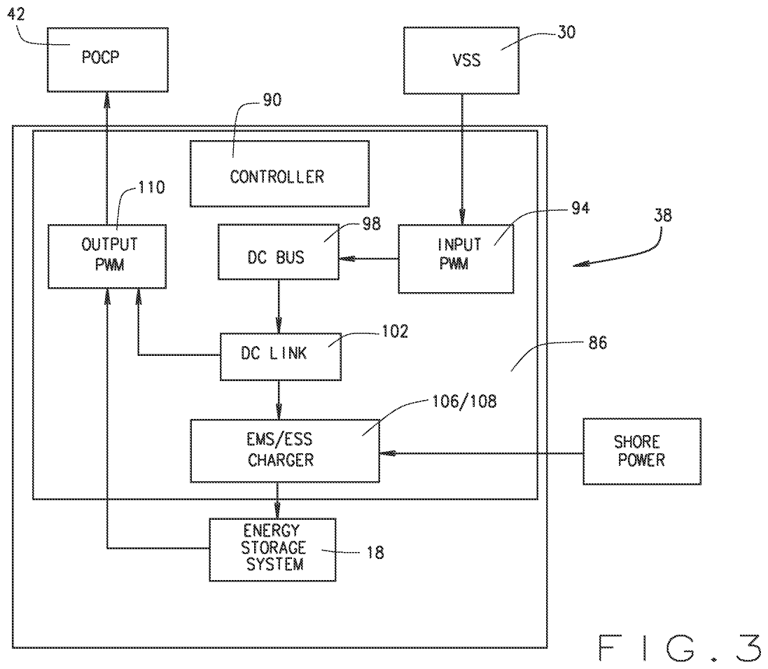

Referring now to FIGS. 1, 2 and 3, in various embodiments, the no-idle subsystem 38 includes the energy storage system 18, which can include one or more energy storage cell (e.g., one or more battery), and power electronics 86 that control the operation (e.g., inputs and outputs) of the no-idle subsystem 38. In various exemplary and non-limiting instances, the power electronics can generally comprise a controller 90, an input PWM (pulse width modulated) drive 94, a DC bus 98, a DC link 102, an energy management system (EMS) 106 and energy storage system charger 108 module and an output PWM (pulse width modulated) drive 110. When the no-idle subsystem 38 is integrated with the generator 22, the transformer 34, the voltage selections switch 30 and the power output control panel 42 to comprise and provide the integrated electrical power generation system 10, the output of voltage selector switch 30 goes to the control panel 42 (as shown in FIGS. 1 and 2), the transformer (as shown in FIG. 1), and the no-idle subsystem 38 (as shown in FIGS. 1 and 3). Hence, the control panel 42 receives inputs from the voltage selector switch 30, the transformer 34, and the no-idle subsystem 38.

In various exemplary and non-limiting embodiments of the no-idle power electronics 86, an output from the voltage selector switch 30 is input to the no-idle subsystem 38 at the input PWM drive 94. The input PWM drive 94 is configured in such a way that it can accept single phase and three phase power at multiple voltage levels. Although the input PWM drive 94 is exemplarily illustrated in FIG. 3 as a single module or device, it is envisioned that the input PWM drive 94 can comprise multiple modules or devices working in concert with each other to comprise the input PWM drive 94. The input PWM drive 94 converts the AC power output (e.g., voltage and current output) of the voltage selector switch 30 to DC power and outputs the DC power to the DC bus 98. The output of the DC bus 98 is input to the DC link 102 which is structured and operable to regulate the voltage received from the input PWM drive 94. The DC link 102 outputs the regulated voltage and current (e.g., power) to the energy management system 106. The no-idle controller 90 and energy management system 106 communicate with the DC link and the energy storage system charger 108. The energy management system 106 is essentially a computer/processor based system, module, e.g., an application specific integrated circuit (ASIC), an electronic circuit, a combinational logic circuit, a field programmable gate array (FPGA), etc., that performs instructions included in code.

The energy management system 106 assesses the state of charge (SOC) of the energy storage system 18 and determines the voltage and current needed to optimally charge the energy storage system 18 in order to maintain an optimal SOC of the energy storage system 18 (e.g., between 20% and 80% of full charge). When the energy storage system 18 has sufficient charge (e.g., greater than 20% full charge) the energy storage system 18 can selectively provide input power to the output PWM drive 110. Particularly, in various instances power delivered to the control panel 42, and hence the load(s) accessing the control panel 42 can be provided solely by the energy storage system 18 such that the prime mover 14 and generator 22 do not need to be operated. This is referred to herein as the no-idle mode.

In various instances, the no-idle power electronic 86 can be configured such that the energy storage system 18 can be charged by power generated by the generator 22 while the energy storage system 18 is simultaneously delivering power to the output PWM drive 110. In such instances, the DC link 102 will provide power to both the EMS/energy storage system charger 106/108 and the output PWM drive 110, and the total sum of charging and output power is limited by the size of the input PWM drive 94. Additionally, in various instances the energy storage system charger 108 can be configured to accept 120V and 240V single phase shore power such that the energy storage system 18 can be charged via the shore power, during ‘down periods’ of use of the system 10 (e.g., during the evening when the system 10 has access to shore power) without relying on the prime mover 14 and generator 22. In various other instances, the DC link 102 can also provide power directly to the output PWM drive 110, bypassing delivery of power to the energy management system 106, the energy storage system charger 108, and the energy storage system 18, such that only power generated by the generator 22 is delivered to the control panel 42. As illustrated in FIG. 3, in all instances, the output of the no-idle subsystem 38 is from the output PWM drive 110. Although the output PWM drive 110 is exemplarily illustrated in FIG. 3 as a single module or device, it is envisioned that the output PWM drive 110 can comprise multiple modules or devices working in concert with each other to comprise the output PWM drive 110.

Referring now to FIGS. 1, 2, 3, 4, 5, and 6, the integrated electrical power generation system 10 is generically illustrated in FIG. 1 as a block diagram. It is envisioned that the components of the system 10 described herein can be disposed on one or more portable and/or mobile platform (e.g., a pull-behind trailer and/or a vehicle such as a truck) and remain within the scope of the present disclosure. For example, as exemplarily illustrated in FIG. 4, in various embodiments all of the components of the system 10 described herein can be disposed on a pull-behind trailer 114. The system 10 and all of the components thereof in such embodiments work, function and operate as described above. It should be noted that in such embodiments, the prime mover 14 is a dedicated prime mover with the primary function of driving the generator 22. Alternatively, as exemplarily illustrated in FIG. 5, in various embodiments, one or more of the components of the system 10 described herein can be disposed on a pull-behind trailer 118 and one or more of the components of the system 10 described herein can be disposed on a vehicle 122, such as a truck or other vehicle. The system 10 and all of the components thereof in such embodiments work, function and operate as described above. It should be noted that in such embodiments, the prime mover 14 is a dedicated prime mover with the primary function of driving the generator 22.

In yet other embodiments, as exemplarily illustrated in FIG. 6, all of the components of the system 10 described herein can be disposed on a vehicle 126, such as a utility vehicle, truck, or other vehicle. The system 10 and all of the components thereof in such embodiments work, function and operate as described above. In such embodiments, the vehicle engine is utilized as the prime mover 14. In such embodiments the primary function of the vehicle engine is to provide motive force to the respective vehicle, and the secondary function of the vehicle engine is to drive the generator 22. For example, in such embodiments, the drivetrain of the respective vehicle can be mechanically modified and enhanced, and integrated with the system 10 to selectively provide motive force to the vehicle or function as the prime mover 14 of the system 10 and be operable to drive the generator 22. In such instances, the vehicle drivetrain can be modified and enhanced as set forth in U.S. published patent application 2015/0045180, filed Jul. 30, 2014, and U.S. published patent application 2017/0021715, filed Oct. 5, 2016, the disclosures of which are incorporated herein in their entirety. For example, in various embodiments, the HMI 78 and controller 82 can be structured, operable and utilized to control various components of the modified and enhanced powertrain such that the vehicle front and/or rear differentials can be disengaged from the vehicle drivetrain, and the output shaft of the vehicle engine and/or transmission can be configured so that the vehicle engine will function as the prime mover 14 of the system 10 and drive the generator 22. For example, in various embodiments, the vehicle drivetrain can be modified and enhanced to comprise a parallel power input gearbox (PPIG) 130 (as described in U.S. published patent applications 2015/0045180 and 2017/0021715) to integrate the vehicle engine and drivetrain with system 10. In such embodiments, as described above, the HMI 78 and controller 82 can be structured, operable and utilized whereby the controller 82 receives inputs from and coordinates the operation of (e.g., receives inputs from and/or generates outputs to) at least the HMI 78, a vehicle engine (prime mover 14) controller (in various instances called an power control module (PCM) or engine control module (ECM), not shown) that is operable to control operation of the vehicle engine (prime mover 14), the voltage regulator 26 that controls operation of the generator, and a plurality of other devices/sensors such as relays (e.g., an overload relay), vehicle engine (prime mover 14) and/or generator 22 oil temperature sensors, the PPIG 130, power take off (PTO) shifting mechanisms, current transformers and/or breakers within the control panel 42, and other voltage sensor(s), current sensor(s), temperature sensor(s), etc., (not shown) of the system 10.

The advantages of the integrated electrical power generation system 10 can be illustrated by comparison of the system 10 to a generator only electrical power generation system consisting of a 70 kVA generator, and/or to a battery only electrical power generation system consisting of 18 kW-Hr energy storage and 18 kW of power charging. For example, the integrated power generation system 10 can substantially simultaneously provide significant single phase power, in various instances greater than 3%-4% of the rated power of the respective generator 22 (e.g., 5 kVA or greater), and significant three phase power, in various instances greater than 50% of the rated power of the respective generator 22 (e.g., 40 kVA or greater). For example, in various embodiments wherein the generator 22 of the system 10 is rated at 70 kVA, the system 10 can simultaneously provide 5 kVA or greater of single phase electrical power and 40 kVA or greater of three phase electrical power. More particularly, in instances where the energy storage system 18 of the no-idle subsystem is not depleted, the system 10 can simultaneously provide single phase power up to the rated energy storage capacity of the energy storage system 18 (e.g., 18 kVA) and three phase power up to the rated output capacity of the generator 22 (e.g., 70 kVA).

Known generator only systems can only produce either significant three phase power (e.g., 68 kVA) with very limited single phase power (e.g., 2 kVA or less single phase), or significant single phase power (e.g., 40 kVA) and no three phase power. In various embodiments, the system 10 can produce full (e.g., 100%) generator rated output (e.g., 70 kVA for a 70 kVA rated generator) while simultaneously providing substantial single phase power, e.g., 100% of the rated storage capacity of energy storage system 18 (e.g., 18 kVA for a 18 kVA rated energy storage capacity) until the energy storage of the energy storage system 18 is depleted. For example, in various embodiments, the system 10 can be operated in the no-idle mode wherein the three phase and/or single phase power can be furnished via the electrical energy stored in the energy storage system 18, up to the rated energy storage capacity of the energy storage system 18 (e.g., 18 kVA). After the energy storage system 18 is depleted the system 10 can simultaneously produce any combination of single phase and three phase power up to the sum limit of the rated output capacity of the generator 22. For example, in various embodiments wherein the energy storage system 18 is depleted, the system 10 can simultaneously produce up to 52 kVA three phase power and 18 kVA single phase power when the generator 22 has a 70 kVA power output rating.

As described above, in various instances, the initial power charging (e.g., 18 kW-Hr) of the energy storage system 18 can be furnished via shore power (e.g., via a separate power generation system, such as grid power). This has several advantages. For example, shore power is much more cost effective than energy provided by running a gasoline or diesel prime mover. The cost effectiveness is a function of the shore power output, cost of electricity, cost of gasoline/diesel, etc. Additionally, by utilizing shore power to initially charge the energy storage system 18 the prime mover 14 does not have to operate at all while the energy storage system 18 is being charged by shore power. This is especially significant when no-idle (e.g., no-noise) operation of the system 10 is desired. Additionally, since the generator and prime mover 22 and 14 are only operated to charge the energy storage system 18 after the energy storage system 18 is depleted, or when simultaneous delivery of significant single phase and three phase power is desired, the prime mover 14 will not be operated at low power levels at which gasoline and diesel engines are very inefficient. Particularly, the minimum load for which the generator 22 will operate is the load the energy storage system 18 will impart on the generator and prime mover 22 and 14 (e.g. 18 kW) when the generator 22 is being operated to charge the energy storage system 18. Additionally, in various exemplary and non-limiting embodiments, the energy storage system charger 108 can be configured to charge the energy storage system 18 at a significant rate (e.g., 18 kW) such that charging time can be reduced. For example, if the energy storage system has a capacity of 18 kW-Hr, and the energy storage system charger 108 is configured to output 18 kW of power, the generator and prime mover 22 and 14 would only have to operate for 1 hour, after which operation of the generator and prime mover 22 and 14 can be discontinued and the single and/or three phase power needed to be delivered by the system 10 can be provided solely by the energy storage system 18. This result in far less fuel being consumed, and less frequent and expensive maintenance of the generator 22 and prime mover 14.

In various embodiments, the generator and prime mover 22/14 will not be operated where the power output by the generator 22 less than a specific low power level threshold (e.g., 18 kW). At power output levels less than the low power level threshold, the power output by the system 10 will be furnished by the energy storage system 18. Subsequently, once the electrical energy stored in the energy storage system 18 is depleted, the energy storage system 18 would be quickly charged (e.g., charged in one hour) at a desired power level (e.g., a power level of 18 kW) by the generator 22. In such embodiments, the minimum power level that the generator and prime mover 22 and 14 (would operate at would be the low power level threshold (e.g., 18 kW), which is defined by the overall system parameters (e.g., the rated power output of the energy storage system charger 108). For example, in various exemplary and non-limiting embodiments, wherein the rated power output of the energy storage system charger 108 is 18 kW, the generator 22 would only be operated to output power equal to or greater than 18 kW (e.g., the generator 22 would never be operated to output less than 18 kW). Power levels less than 18 kW will be provided by the energy storage system 18 only. And, when the energy storage system 18 is depleted, the generator 22 will be operated to output at least the 18 kW required by the energy storage system charger 108 to charge the energy storage system 18.

As another example wherein the rated power output of the energy storage system charger 108 is 18 kW and the energy storage system 106 is structured and operable to have an 18 kW-Hr energy storage, if the power output of the system 10 required by one or more load (e.g., one or more power consumption device) connected to the system 10 is 6 kW, the energy storage system 18 will supply the 6 kW for three hours, after which the generator 22 would be operated for 1 hour to charge the energy storage system 18 and simultaneously provide the 6 kW to the load(s). Hence, in the 18 kW-Hr example, for an exemplary need of 6 kW of power delivery to one or more load (e.g., one or more power consumption device) for an entire 8 hour work day, the initial charge from shore power would allow energy storage system 18 to provide the 6 kW of power (single and/or three phase) for three hours. Thereafter, for the 4th hour the generator 22 and prime mover 14 would be operated to provide the needed 6 kW of power delivery to the load(s) and to simultaneously provide 18 kW of power to charge the energy storage system 18. At 18 kW output by the generator 22, the energy storage system 18 would be fully charged in 1 hour, after which operation of the generator and prime mover 22 and 14 can be discontinued. Thereafter, the energy storage system 18 can again solely be utilized to provide the 6 kW to the load(s) for the next 3 hours. Then, the generator and prime mover 22 and 14 can again be operated for an hour to simultaneously charge the energy storage system 18, and provide the needed 6 KW of power to the load(s). Hence, in such a scenario, to provide the needed 6 kW of power to the load(s) for an entire 8 hours, the generator and prime mover 22 and 14 would only need to be run for a total of 2 hours. Therefore, the generator 22 and prime mover 14 would be operated for a minimal amount of time (e.g., two hours) for the entire day (for the purposes of generating electrical power) even though a substantial amount of work was being done all day (e.g., 6 kW of work, for 8 hours (which represents 48 kW-Hr of work). Moreover, the system 10 provided substantially quiet power provision, saved on fuel, and minimized wear on the generator 22, prime mover 14 and related exhaust system(s).

The above examples are merely mathematical examples, however, in various embodiments to extend the life of the energy storage system 18 the energy management system 106 and energy storage system charger 108 can be structured and operable to only charge the energy storage system 18 to a maximum charge level (e.g., 70%, 80%, 90%, etc. of full charge) and allow the energy storage system 18 to discharge only to a minimum charge level (e.g., 10%, 20%, 30%, etc. of full charge). Hence the times between running the engine/gen can be shorter than exemplarily described above. However, the above example is still representative of the fuel and maintenance savings advantages of the system 10 over known systems where the prime mover would be idling all day to keep the generator running all day.

It should be noted that the 18 kW rating of the energy storage system charger 108 and the 18 kW capacity of the energy storage system 18 in the above example scenario (and throughout this disclosure) are only exemplary and not limiting. Accordingly, the generator 22 will be operated for a period of time until the energy storage system 18 is fully charged based on the output rating of the energy storage system charger 108.

One of many advantages of the system 10 is that the system 10 can provide three phase power (via the generator 22 and prime mover 14) at or near the rated output of the generator 22 (e.g., 70 kVA) while simultaneously providing significant single phase power (e.g., 18 kVA) up to the rated capacity of the energy storage system 18 (e.g., 18 kW-Hr).

Another advantage of the system 10 is that when the energy storage system 18 is depleted, some of the three phase power output by the generator 22 can be converted it to single phase, via the no-idle subsystem 38, to simultaneously provide three phase and single phase power, all the while simultaneously charging the energy storage system 18. For example, wherein the generator 22 is rated at 70 kVA, the system 10 can be operated to simultaneously provide 52 kVA three phase power to one or more load (e.g., one or more power consumption device), and convert the remaining 18 kVA three phase output by the generator 22 to single phase via the no-idle subsystem to provide single phase power, for example 3 kVA or greater, to one or more load (e.g., one or more power consumption device), and simultaneously charge the energy storage system 18.

Yet another advantage of the system 10 is that the energy storage cells (e.g., battery(ies)) of the energy storage system 18 is/are optimally maintained. Energy storage cells, such as batteries, are most often operated as necessary to suit conditions. For instance, if the energy cells (e.g., batteries) are totally charged overnight, and then they are used in an area where it not possible to recharge, the energy storage cells (e.g., batteries) are fully depleted (i.e. discharged to a 0% or near 0% charge). Thus, the energy storage cells (e.g., batteries) of known power generation systems are typically operated from being fully charged (e.g., charged to a SOC of 100%) to being fully discharged (e.g., discharged to a SOC of 0%). Deep cycling energy storage cells (e.g., batteries) in this fashion is damaging to the energy storage cells (e.g., batteries) and severely shortens their life. Additionally, if the energy storage cells (e.g., batteries) have to support a high load whereby the energy storage cells (e.g., batteries) are discharged at a high rate, this also will shortened the life of the energy storage cells (e.g., batteries).

Generally, for optimal life, the energy storage cell(s) (e.g., battery(ies)) of the energy storage system 18 must be operated within limits of specific parameters. One such parameter is the state-of-charge (SOC) of the energy storage cell(s) (e.g., battery(ies)). In particular, in order for the energy storage cell(s) (e.g., battery(ies)) of the energy storage system 18 to have a maximum life, the energy storage cell(s) (e.g., battery(ies)) of the energy storage system 18 should only be discharged to a minimum charge level that is not lower than a prescribed low limit and only be charged to a maximum charge level that does not exceed a prescribed upper limit. For example, lithium based batteries (commonly used for large energy storage because they have a high energy storage density) are particularly sensitive to SOC. Lithium based batteries typically should not be discharged below a 20% SOC and not charged to more than an 80% SOC.

As described above, in various embodiments the system 10 provides an onboard charging system, i.e., the energy management system 106 and energy storage system charger 108, that is structured and operable to maintain the SOC of energy storage cell(s) (e.g., battery(ies)) between an optimal maximum charge level that is less than 100% of the rated energy storage capacity of the energy storage system 18 (e.g., 70%, 80%, 90%, etc., of full charge) and an optimal minimum charge level that is greater than 0% of the rated energy storage capacity of the energy storage system 18 (e.g., 10%, 20%, 30%, etc., of full charge).

What is claimed is:

1. A method of providing electrical power at locations where shore power is unavailable, utilizing a vehicle integrated electrical power generation system, said method comprising:
selectively disengaging a powertrain of the vehicle from at least one of a front differential and a rear differential;
selectively engaging a parallel power input gearbox of the integrated electrical power generation system with the powertrain;
selectively engaging the parallel power input gearbox with a generator of the integrated electrical power generation system that is disposed on the vehicle;
driving the powertrain of the vehicle utilizing an engine of the vehicle that is mechanically connected to the powertrain wherein the primary function of the engine and powertrain combination is to provide motive power to propel movement of the vehicle;
driving the generator of the integrated electrical power generation system utilizing the parallel power input gearbox selectably connected to the powertrain and the engine of the vehicle such that the engine drives the generator,
providing to a first external load three phase power via the generator of the electrical integrated electrical power generation system, wherein the provided three phase power can be at least 50% of a rated power output of the generator; and
simultaneously providing to a second external load single phase power via a no-idle subsystem of the integrated power generation system, wherein the provided single phase power can be at least 3% of the rated power output of the generator.

2. The method of claim 1, wherein the provided three phase power can be between 50% and 100% of the rated power output of the generator, and the single phase power can be between 3% of the rated power output of the generator and 100% of a rated storage capacity of an energy storage system of the no-idle subsystem.

3. The method of claim 1 further comprises simultaneously utilizing a portion of a power output by the generator to charge an energy storage system of the no-idle subsystem.

4. The method of claim 1 further comprising maintaining a state of charge of an energy storage system of the no-idle subsystem of the integrated electrical power generation system between a minimum charge level and a maximum charge level that are respectively greater than 0% and less than 100% of a rated energy storage capacity of the energy storage system via an energy management system of the integrated electrical power generation system via a voltage selector switch of the integrated electrical power generation system.

5. The method of claim 4, wherein the state of charge of the energy storage system is maintained between 20% and 80% of a rated energy storage capacity of the energy storage system via an energy management system of the integrated electrical power generation system.

6. The method of claim 4, wherein the no-idle subsystem can be charged via the shore power, and the integrated electrical power generation system can provide power strictly from the no-idle subsystem utilizing only the state of charge from the shore power.

7. The method of claim 1 further comprising operating a prime mover of the integrated electrical power generation system that drives the generator such the prime mover will never operate to drive the generator at less than 18 kW.

8. An integrated electrical power generation system, said system comprising:
a generator structured and operable to output three phase power;
an engine of a vehicle on which the system can be disposed;
a powertrain of the vehicle mechanically connected to the engine such that the primary function of the engine and powertrain is to provide motive power to propel the vehicle, wherein the powertrain is modified to be selectively disengageable from at least one of a front differential and a rear differential of the vehicle;
a parallel power input gearbox that is selectively engageable with the powertrain and the generator such that the powertrain and parallel power input gearbox can be driven by the vehicle engine to drive the generator;
a control panel structured and operable to electrically connect at least one load to the integrated electrical power generation system and to control various settings and operational parameters of the integrated electrical power generation system;
a voltage selector switch structured and operable to receive the three phase power generated from the generator and selectively distribute the received three phase power to one or more of:
a transformer structured and operable to selectively raise and lower the electrical power received from the voltage selector switch and output the raised and lowered electrical power to the control panel; and
a no-idle subsystem structured and operable to selectively receive the electrical power from the voltage selector switch and to output voltage electrical power to the control panel, such that the integrated electrical power generation system can simultaneously output three-phase power to a first external load and single-phase power to a second external load.

9. The system of claim 8 wherein the system is one of:
disposed on a pull-behind trailer; and
disposed partially on a pull-behind trailer and partially on a vehicle to which the pull-behind trailer can be connected.

10. The system of claim 9 wherein the system is disposed on a vehicle.

11. The system of claim 8, wherein the system is structured and operable to provide the three phase power via generator of an integrated electrical power generation system, wherein the provided three phase power can be at least 50% of a rated power output of the generator, and simultaneously provide single phase power via a no-idle subsystem of the integrated electrical power generation system, wherein the provided single phase power can be at least 3% of the rated power output of the generator.

12. The system of claim 11, wherein the system is structured and operable to the provide the three phase power between 50% and 100% of the rated power output of the generator, and provide the single phase power can be between 3% of the rated power output of the generator and 100% of the rated storage capacity of an energy storage system of the no-idle subsystem.

13. The system of claim 11, wherein the system is structured and operable to simultaneously utilize a portion of a power output by the generator to charge an energy storage system of the no-idle subsystem.

14. The system of claim 11 wherein the system is structured and operable to maintain a state of charge of an energy storage system of no-idle subsystem between a minimum charge level and a maximum charge level that are respectively greater than 0% and less than 100% of a rated energy storage capacity of the energy storage system via an energy management system of the integrated electrical power generation system via a voltage selector switch of the integrated electrical power generation system.

15. The system of claim 14, wherein the state of charge of the energy storage system is maintained between 20% and 80% of a rated energy storage capacity of the energy storage system via an energy management system of the integrated electrical power generation system.

16. A vehicle for providing electrical power at locations where shore power is unavailable, said vehicle comprising:
an engine;
at least one of a front differential and a rear differential;
a powertrain operably connected to the engine such that the engine and powertrain are structured and operable to provide motive force to propel the vehicle; and
an integrated electrical power generation system, wherein the system comprises:
a generator structured and operable to output three phase power;
a prime mover comprising the vehicle engine;
the powertrain mechanically connected to the engine, wherein the powertrain has been modified to be selectively disengageable from at least one of the at least one front differential and rear differential of the vehicle;
a parallel power input gearbox that is selectively engageable with the powertrain and the generator such that the vehicle engine, parallel power input gearbox and powertrain are structured and operable to drive the generator;
a control panel structured and operable to electrically connect at least one load to the integrated electrical power generation system and to control various settings and operational parameters of the integrated electrical power generation system;
a voltage selector switch structured and operable to receive the three phase power generated from the generator and selectively distribute the received three phase power to one or more of:
a transformer structured and operable to selectively raise and lower the electrical power received from the voltage selector switch and output the raised and lowered electrical power to the control panel; and
a no-idle subsystem structured and operable to selectively receive the electrical power from the voltage selector switch and to output voltage electrical power to the control panel, such that the integrated electrical power generation system can simultaneously output three-phase power to a first external load and single-phase power to a second external load.

17. The vehicle of claim 16, wherein the integrated electrical power generation system is structured and operable to provide three phase power via the generator, wherein the provided three phase power can be at least 50% of a rated power output of the generator; and simultaneously provide single phase power via the no-idle subsystem wherein the provided single phase power can be at least 3% of the rated power output of the generator.

18. The vehicle of claim 17, wherein the integrated electrical power generation system is structured and operable to the provide the three phase power between 50% and 100% of the rated power output of the generator, and provide the single phase power can be between 3% of the rated power output of the generator and 100% of a rated storage capacity of an energy storage system of the no-idle subsystem.

19. The vehicle of claim 17, wherein the integrated electrical power generation system is structured and operable to simultaneously utilizing a portion of a power output by the generator to charge an energy storage system of the no-idle subsystem.

20. The vehicle of claim 17 wherein the integrated electrical power generation system is structured and operable to maintain a state of charge of an energy storage system of the no-idle subsystem between a minimum charge level and a maximum charge level that are respectively greater than 0% and less than 100% of a rated energy storage capacity of the energy storage system via an energy management system of the integrated electrical power generation system via a voltage selector switch of the integrated electrical power generation system.
